(19) United States
(12) Patent Application Publication
(10) Pub. No.: US 2025/0201503 A1
(43) Pub. Date: Jun. 19, 2025

(54) MULTI-CONTACT MINIATURE CIRCUIT BREAKER WITH REDUCED ARCING

(71) Applicant: EATON INTELLIGENT POWER LIMITED, DUBLIN 4 (IE)

(72) Inventor: Venkat raman Thenkarai Narayanan, Prague (CZ)

(73) Assignee: EATON INTELLIGENT POWER LIMITED, DUBLIN 4 (IE)

(21) Appl. No.: 19/073,607

(22) Filed: Mar. 7, 2025

Related U.S. Application Data
(63) Continuation-in-part of application No. 18/539,623, filed on Dec. 14, 2023.

(51) Int. Cl. H01H 71/02; H01H 71/10

(52) U.S. Cl. CPC H01H 71/02; H01H 71/10

(57) ABSTRACT

A circuit breaker includes two sets of separable contacts in series per pole, primary contacts and secondary contacts, reducing overall let-through energy and peak pressures within the arcing chambers of the breaker during arc interruption. Opening both sets of contacts produces two arcs in series per pole, and the two series arcs increase the line to load resistance of the breaker relative to when only one set of contacts are opened. The increased line to load resistance causes the peak let-through current, Ipk, to decrease relative to what Ipk would be if only one set of contacts were to be opened. The circuit breaker also includes an internal primary vent that vents gases away from the primary contacts to another area within the circuit breaker housing, and a secondary exhaust vent that vents gases away from the secondary contacts to the exterior of the circuit breaker.

### CROSS REFERENCE TO RELATED APPLICATIONS

This application claims priority to U.S. patent application Ser. No. 18/539,623, filed on Dec. 14, 2023, and titled “MULTI-CONTACT MINIATURE CIRCUIT BREAKER WITH REDUCED ARCING” the disclosure of which is incorporated herein by reference.

### FIELD OF THE INVENTION

The disclosed concept relates generally to circuit breakers, and in particular, to devices and systems for mitigating the effects of arcing within circuit breakers.

### BACKGROUND OF THE INVENTION

Circuit interrupters, such as for example and without limitation, circuit breakers, are typically used to protect electrical circuitry from damage due to an overcurrent condition, such as an overload condition, a short circuit, or another fault condition, such as an arc fault or a ground fault. Circuit interrupters typically include mechanically operated separable electrical contacts, which operate as a switch. When the separable contacts are in contact with one another in a closed state, current is able to flow through any circuits connected to the circuit interrupter. When the separable contacts are separated from one another in an open state, current is prevented from flowing through any circuits connected to the circuit interrupter. The separable contacts may be operated either manually by way of an operator handle, remotely by way of an electrical signal, or automatically in response to a detected fault condition. Typically, such circuit interrupters include an actuator designed to rapidly close or open the separable contacts, and a trip mechanism, such as a trip unit, which senses a number of fault conditions to trip the separable contacts open automatically using the actuator. Upon sensing a fault condition, the trip unit trips the actuator to move the separable contacts to their open position.

Typically, when a circuit interrupter opens its separable contacts during a fault condition, an arc is generated across the contacts. The circuit interrupter is only considered fully open when the arc is completely extinguished. Arcing produces significant heat, which in turn can significantly increase the pressure within the circuit interrupter, and this heat and pressure can cause irreversible damage if the arc is not extinguished as quickly as possible. In miniature circuit breakers in particular, the arc that is generated under high fault currents can create high pressures and let-through energy that can lead to destruction or degradation of the circuit breaker case and current-carrying components, making it difficult to fulfill an ongoing desire to produce circuit breaker cases from more sustainable thermoplastics.

There is thus room for improvement in arc mitigation devices and systems in circuit breakers, including miniature circuit breakers.

### SUMMARY OF THE INVENTION

These needs, and others, are met by embodiments of an improved circuit breaker that includes two sets of separable contacts in series, a set of primary contacts and a set of secondary contacts. Including both sets of separable contacts in series reduces overall let-through energy and peak pressure within the arcing chambers of the circuit breaker during an arc interruption event, relative to what the let-through energy and peak pressure would be if only one set of contacts were to be opened. Furthermore, in addition to a standard primary external vent that exhausts gas generated by separation of the primary contacts to the exterior of the circuit breaker, the disclosed improved breaker also includes a new internal primary vent that exhausts gas generated by the primary contacts to other interior areas of the circuit breaker and a new secondary external vent that exhausts gas generated by separation of the secondary contacts to the exterior of the circuit breaker. The inclusion of the internal primary vent and the secondary external vent further reduces peak pressure within the circuit breaker significantly, relative to what the pressure would be if only the primary external vent were included.

In one exemplary embodiment of the disclosed concept, a circuit breaker comprises: a housing; a line side structured to electrically connect to a power source; a load side structured to electrically connect to a load; a first set of separable contacts, the first set of separable contacts being primary contacts electrically connected between the line side and the load side; a second set of separable contacts, the second set of separable contacts being secondary contacts electrically connected between the line side and the load side; an operating mechanism structured to open and close the primary contacts; a thermal magnetic arrangement configured to open the primary contacts from a closed state once current reaches a predetermined severity threshold; a secondary actuator structured to open the secondary contacts from a closed state; a printed circuit board (PCB); an internal primary vent; and a secondary exhaust vent. The primary contacts and the secondary contacts are in series. The internal primary vent is structured to vent gas away from the vicinity of the primary contacts and into an area internal to the housing. The secondary exhaust vent is structured to vent gas away from the secondary contacts to an exterior of the housing. The PCB is structured to monitor electrical conditions in the circuit breaker and to actuate the secondary actuator. The PCB is configured such that, when the primary contacts are closed and the secondary contacts are closed, the PCB actuates the secondary actuator to open the secondary contacts simultaneously during thermal-magnetic opening of the primary contacts in response to detecting a fault condition exceeding a predetermined severity threshold.

### BRIEF DESCRIPTION OF THE DRAWINGS

A full understanding of the invention can be gained from the following description of the preferred embodiments when read in conjunction with the accompanying drawings in which:

FIG. 1A is a sectional view of one pole of an improved circuit breaker that includes two sets of separable contacts in series, along with an internal primary vent, a secondary external vent, and a primary external vent, in accordance with an example embodiment of the disclosed concept;

FIG. 1B is a partial isometric view of the exterior of the improved circuit breaker shown in FIG. 1A, providing an external view of the two exhaust vents included in each of the two poles of the circuit breaker;

FIG. 2 is a schematic block diagram depicting the two poles of the circuit breaker shown in FIGS. 1A-1B and how the two sets of separable contacts in series per pole are connected between a line side and a load side of the circuit breaker, in accordance with an example embodiment of the disclosed concept;

FIG. 3A is an enlargement of a portion of the circuit breaker shown in FIG. 1A, shown in a sectional view taken along a cutting plane parallel to the cutting plane of the sectional view shown in FIG. 1A, showing a first embodiment of an internal vent for exhausting gases generated by the primary separable contacts, in accordance with an example embodiment of the disclosed concept;

FIG. 3B is an enlargement of a portion of the circuit breaker shown in FIG. 1A, shown in a sectional view taken along a cutting plane parallel to the cutting plane of the sectional view shown in FIG. 1A, showing a second embodiment of an internal vent for exhausting gases generated by the primary separable contacts, in accordance with an example embodiment of the disclosed concept;

FIG. 4 is a flow line diagram showing the velocities of gases produced during a simulation of a separation of the primary contacts of the circuit interrupter shown in FIGS. 1A and 1B, when breaker only includes a primary exhaust vent;

FIG. 5 is a flow line diagram showing the velocities of gases produced during a simulation of a separation of the primary contacts of the circuit interrupter shown in FIGS. 1A and 1B, when breaker includes both an internal primary vent and a primary exhaust vent;

FIG. 6 is a table comparing peak current and pressure data for fault event simulations for a first condition where the circuit breaker only includes a primary exhaust vent, for a second condition where the circuit breaker includes a secondary exhaust vent and a primary exhaust vent, and for a third condition where the circuit breaker includes an internal primary vent, a secondary exhaust vent, and a primary exhaust vent;

FIG. 7 is a perspective view of an arc chamber that includes a first embodiment of an arc chute and can be included in the circuit breaker shown in FIG. 1, in accordance with an example embodiment of the disclosed concept;

FIG. 8 is a perspective view of an arc chamber that includes a second embodiment of an arc chute and can be included in the circuit breaker shown in FIG. 1, in accordance with an example embodiment of the disclosed concept;

FIG. 9A is an enlargement of a portion of the improved circuit breaker shown in FIG. 1A where a contact spring resides, depicting the direction of hot gas flow generated in the arc chamber on the primary side;

FIG. 9B shows the same portion of the circuit breaker shown in FIG. 9A, with a protective spring guard added around the contact spring, in accordance with another example embodiment of the disclosed concept;

FIG. 10A is an isometric view from a first side of a portion of a primary side movable conductor arm from the circuit breaker shown in FIGS. 1A-1B, with insulation added to the movable conductor arm, in accordance with another example embodiment of the disclosed concept;

FIG. 10B is an isometric view from a second side of the portion of the primary side movable conductor arm with added insulation shown in FIG. 10A;

FIG. 11A is a sectional view of a portion of the secondary side of one pole of the improved circuit breaker shown in FIG. 1A, showing an enlarged view of the portions of the movable and stationary conductors that include the respective movable and stationary contacts;

FIG. 11B shows a rotated perspective of the view shown in FIG. 11A;

FIG. 12 shows the same portion of the circuit breaker shown in FIG. 11A, with the proportions of the movable and stationary conductors shown in FIG. 11A modified in order to reduce the size of the reverse current loop, in accordance with another example embodiment of the disclosed concept;

FIG. 13A shows a portion of the partial isometric view shown in FIG. 1B of the exterior of one pole of the improved circuit breaker, showing an auxiliary vent added to the primary side above a primary exhaust vent shown in FIG. 1B, in accordance with another example embodiment of the disclosed concept;

FIG. 13B is a view of the interior of the pole shown in 13A, depicting how the auxiliary vent improves the exhaust of hot gas flow from the primary side; and

FIG. 13C is an enlargement of a portion of the view shown in FIG. 13B, showing an area of the interior of the pole that benefits from the improved exhaust flow facilitated by the auxiliary vent shown in FIGS. 13A and 13B.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

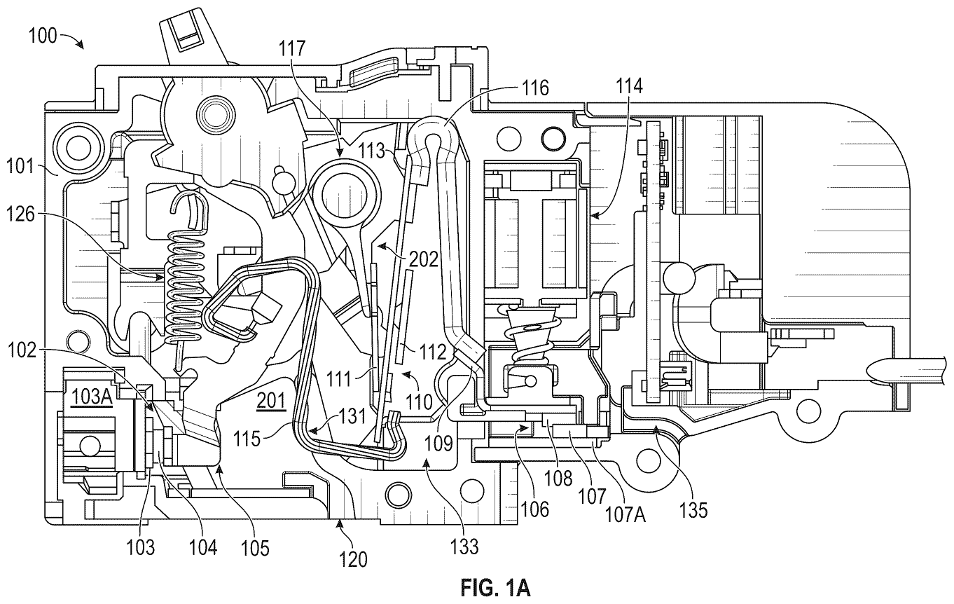

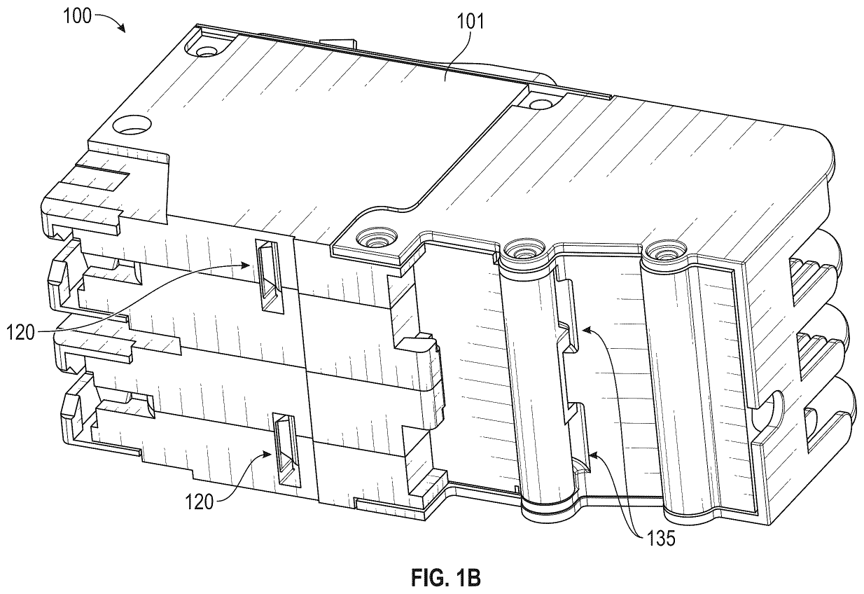

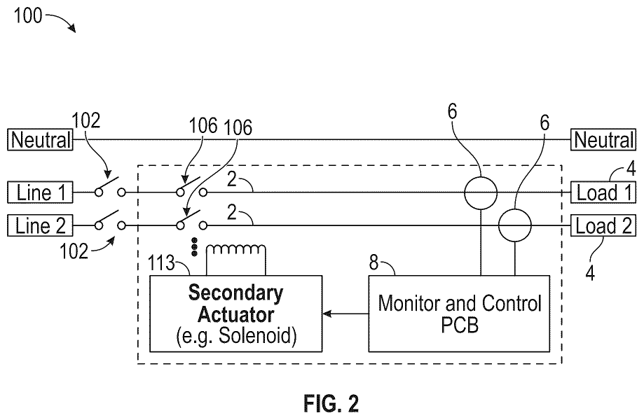

Described herein are embodiments of an improved circuit breaker 100 that includes two sets of separable in series per pole in order to reduce overall let-through energy during an arc interruption event and thus reduces peak pressures within the arcing chambers of the circuit breaker. FIG. 1A is a sectional view of a single pole of the improved circuit breaker 100 and FIG. 1B is a partial isometric view of the exterior of the 2-pole improved circuit breaker 100, in accordance with an example embodiment of the disclosed concept. FIG. 2 provides a schematic representation of the 2 poles of the circuit interrupter 100. The circuit breaker 100 can comprise, for example and without limitation, a miniature circuit breaker. Each pole of the circuit breaker comprises identical components, and it will be appreciated that the sectional view shown in FIG. 1A can depict either of the two poles shown in FIG. 1B. While the circuit breaker 100 is depicted as a 2-pole circuit breaker in the figures, particularly FIG. 1B and FIG. 2, it should be noted that the 2-pole embodiment is an illustrative example, as the advantageous features of the circuit breaker 100 are implemented within each pole of the circuit breaker 100. That is, the features of the improved circuit breaker 100 can be implemented within a circuit breaker having only a single pole or having more than 2 poles without departing from the scope of the disclosed concept.

The circuit breaker 100 includes a housing 101, which can comprise, for example and without limitation, a thermoplastic case which houses the electromechanical components of the circuit breaker 100. The circuit breaker 100 further comprises two sets of separable contacts per pole positioned in series. The first set of separable contacts are the primary contacts 102, which includes a primary stationary contact 103 and a primary movable contact 104. The primary stationary contact 103 is disposed at one end of a primary stationary conductor 103A. The primary movable contact 104 is disposed at one end of a first movable conductor 105. The first movable conductor 105 is formed as an arm and is thus also referred to herein as the primary movable arm 105. The second set of separable contacts are the secondary contacts 106, which includes a secondary stationary contact 107 and a secondary movable contact 108. The secondary stationary contact 107 is disposed at one end of a secondary stationary conductor 107A. The secondary movable contact 108 is disposed at one end of a second movable conductor 109. The second movable conductor 109 is formed as an arm and is thus also referred to herein as the secondary movable arm 109. The primary and secondary stationary contacts 103, 107 remain stationary relative to the housing 101, while the primary and secondary movable contacts 104, 108 are structured to move between closed and open positions. Existing circuit breakers typically include only one set of separable contacts, with said one set of separable contacts being comparable to the primary contacts 102 of the circuit breaker 100, and it should be noted that the inclusion of the secondary contacts 106 in addition to the primary contacts 102 represents an improvement over existing circuit breakers for reasons that will become apparent later herein.

In FIG. 1A, the primary contacts 102 are depicted as being closed (i.e. in a closed state), wherein the primary movable contact 104 is in a closed position such that it is in physical contact with the primary stationary contact 103. The secondary contacts 106 are also depicted as being closed (i.e. in a closed state), wherein the secondary movable contact 108 is in a closed position such that it is in physical contact with the secondary stationary contact 107. As detailed further later herein, the primary movable contact 104 can be moved from the closed position shown in FIG. 1A to an open position (in which it is separated from the primary stationary contact 103 by a gap) by a thermal magnetic arrangement 110 comprising an armature 111 and a plate 112 attached to a bimetal strip 113. Similarly, the secondary movable contact 108 can be moved from the closed position shown in FIG. 1 to an open position (in which it is separated from the secondary stationary contact 107 by a gap) by a secondary actuator 114. In FIG. 1, the secondary actuator 114 is a solenoid. As such, the secondary actuator 114 is referred to hereinafter as the “solenoid 114”, but any device suitable for use in actuating the secondary contacts 106 between the open and closed states and can be used as a secondary actuator 114 in the circuit breaker 100 without departing from the scope of the disclosed concept.

FIG. 2 provides a simplified depiction of how the primary and secondary contacts 102, 106 are positioned between the line side and the load side of the circuit breaker 100. Each pole of the circuit breaker 100 includes a line conductor 2 structured to electrically connect a power source (not shown) to a load 4. The circuit breaker 100 is structured to trip open in order to interrupt current flowing between the power source and load 4 in each pole in the event of a fault condition (e.g., without limitation, an overcurrent condition) in order to protect the load 4 and circuitry associated with the load 4, as well as the power source. The circuit breaker 100 further includes a current sensor 6 and a monitor and control PCB 8, referred to hereinafter as the “PCB 8” for brevity. As detailed further herein, the PCB 8 monitors conditions in the circuit breaker 100 and initiates tripping of the secondary contacts 106.

The opening of the primary contacts 102 during an overcurrent fault will now be detailed. Under normal operating conditions, the primary and secondary contacts 102, 106 are closed, enabling current to flow from the power source to the primary stationary conductor 103A to the primary contacts 102 to the primary movable arm 105 to a first flexible conductor 115 to the bimetal strip 113 to a second flexible conductor 116 to the secondary movable arm 109 to the secondary contacts 106 to the secondary stationary conductor 107A to the load 4. It will be appreciated that each line conductor 2 depicted in FIG. 2 comprises all of the components shown in FIG. 1A and listed above that enable power to flow from the power source to each load 4 in a given pole (i.e. the primary stationary conductor 103A, primary movable arm 105, the first flexible conductor 115, the bimetal strip 113, the second flexible conductor 116, the secondary movable arm 109, and the secondary stationary conductor 107A).

Under an overcurrent fault condition, the high magnitude of the fault-level current flowing through the circuit breaker 100 generates a large enough magnetic field within the armature 111 to enable the magnetic attraction between the armature 111 and the plate 112 to move the armature 111 toward the plate 112 and actuate movement of the movable arm 105 via an operating mechanism 117, thus tripping open the primary contacts 102 by separating the primary movable contact 104 from the primary stationary contact 103.

From the description provided above, it should be noted that the opening of the primary contacts 102 during an overcurrent condition is actuated by the thermal-magnetic and electromechanical components (e.g. the bimetal strip 113, the armature 111, the metal plate 112, the operating mechanism 117) of the circuit breaker 100. In contrast, opening of the secondary contacts 106 is initiated by the PCB 8. The PCB 8 is configured to monitor power flowing through the circuit breaker 100 via the current sensor 6 and/or other sensors and to detect fault conditions based on the power flowing through the circuit breaker 100. More specifically, the PCB 8 is configured to initiate tripping of the secondary contacts 106 based on the same conditions that cause the thermal-magnetic and electromechanical components to trip open the primary contacts 102. In response to detecting a fault condition, the PCB 8 is configured to trip open the secondary contacts 106 simultaneously with the thermal-magnetic opening of the primary contacts 102 initiated through the armature 111, plate 112, and bimetal strip 113. The PCB 8 is configured to determine a severity level of a fault condition based on a number of predetermined severity thresholds.

Opening both the primary and secondary contacts 102, 106 stops the flow of current from the power source 3 to the load 4 and minimizes let-through current and the effects of arcing, as detailed further later herein. It will be appreciated that only opening the primary contacts 102 while keeping the secondary contacts 106 closed also stops the flow of current from the power source 3 to the load 4, but does not minimize let-through current. In addition, only opening the primary contacts 102 while keeping the secondary contacts 106 closed can potentially lead to tack welding of the secondary contacts 106 due to the effects of arcing in high severity fault conditions.

When the circuit breaker 100 is connected between the power source and the load 4 and operating to supply power to the load 4, a voltage exists across the interface between the primary movable contact 104 and the primary stationary contact 103 (referred to hereinafter as the “primary interface voltage”), and another voltage exists between the secondary movable contact 108 and the secondary stationary contact 107 (referred to hereinafter as the “secondary interface voltage”). It will be appreciated that the primary interface voltage is negligible when the primary contacts 102 are closed and that the secondary interface voltage is negligible when the secondary contacts 106 are closed.

When the primary contacts 102 are opened under a fault condition, the primary interface voltage causes arcing across the gap created by the primary movable contact 104 moving away from the primary stationary contact 103. Similarly, when the secondary contacts 106 are opened under a fault condition, the secondary interface voltage causes arcing across the gap created by the secondary movable contact 108 moving away from the secondary stationary contact 107. Let-through current is the current that continues to be let through the circuit breaker 100 from the power source to the load 4 as a result of arcing while either set of separable contacts 102, 106 is opening. In addition to producing let-through current, arcing also generates significant heat, which causes a significant pressure increase within the interior of the housing 101.

If only the primary contacts 102 were opened under a high severity fault condition (i.e. while the secondary contacts 106 were kept closed) such that there was only arcing across the interface of the primary contacts 102, this would reproduce the conditions that exist in known circuit breakers that only include one set of separable contacts between a power source and a load. In the improved circuit breaker 100, opening both the primary contacts 102 and the secondary contacts 106 under a high severity fault condition produces two arcs in series per pole, and the two arcs in series increase the line to load resistance per pole of the circuit breaker 100 relative to what the line to load resistance is when only the primary contacts 102 are opened. Under high severity fault conditions, the increased line to load resistance of the circuit breaker 100 that results from opening both the primary and secondary contacts 102, 106 causes the peak let-through current, Ipk, to decrease relative to what Ipk would be if only the primary contacts 102 were to be opened while the secondary contacts 106 were to remain closed.

Reducing the peak let-through current Ipk also reduces the pressure within the circuit breaker 100 caused by gases produced during arcing. The circuit breaker 100 also advantageously includes additional vents that are not found in known circuit breakers in order to further reduce the pressure caused by gases produced during arcing. Referring to FIG. 1A, it is noted that the circuit breaker 100 includes a primary exhaust vent 120 that vents gases produced by the primary contacts 102 to the exterior of the circuit breaker housing 101. The primary exhaust vent 120 is a feature that can be found in known circuit breakers. However, unlike known circuit breakers, the circuit breaker 100 additionally includes an internal primary vent 131 that vents gases generated by the primary contacts 102 away from the vicinity of the primary contacts 102 and into another area within the interior of the housing 101. For example and without limitation, the internal primary vent 131 can vent gases into a main primary mechanism area 133 within the interior of the housing 101. The main primary mechanism area 133 is an area that includes, for example and without limitation, the armature 111, the metal plate 112, the bimetal strip 113, and the operating mechanism 117.

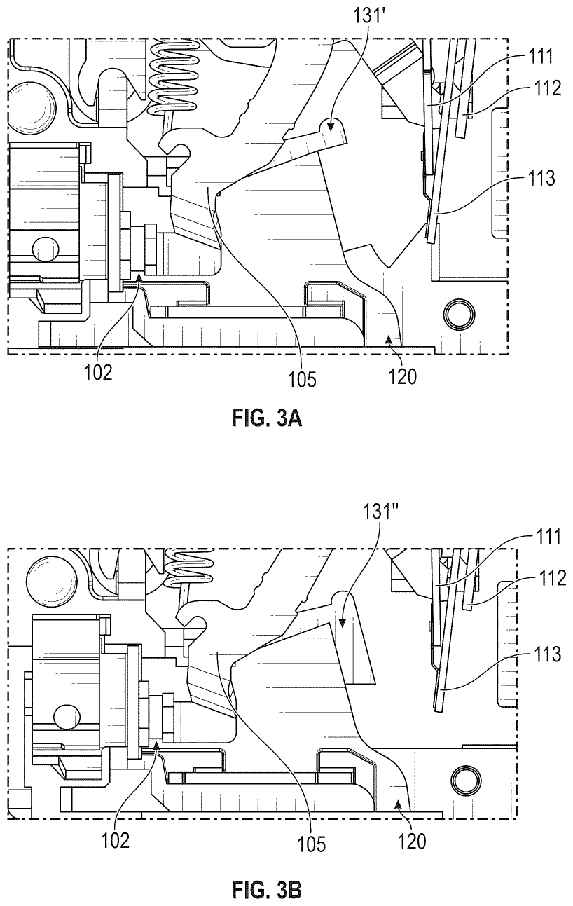

Enabling gases produced during opening of the primary contacts 102 to vent into the main primary mechanism area 133 in addition to venting to the exterior of the housing 101 through the primary exhaust vent 120 enables the gases to disperse from the immediate vicinity of the primary contacts 102 more quickly due to the additional flow area available to the gases. This offers additional reduction in pressure within the circuit breaker 100 that is not found in known circuit breakers that only include an external exhaust vent such as the primary exhaust vent 120. The internal primary vent 131 can vary in depth and cross-section without departing from the scope of the disclosed concept, and two non-limiting illustrative example embodiments of the shape that the internal primary vent 131 can take are shown in FIG. 3A and FIG. 3B, numbered respectively with the reference numbers 131′ and 131″. It will be appreciated that the geometry of the internal vent 131 can be adjusted depending on how exhaust gas needs to be routed.

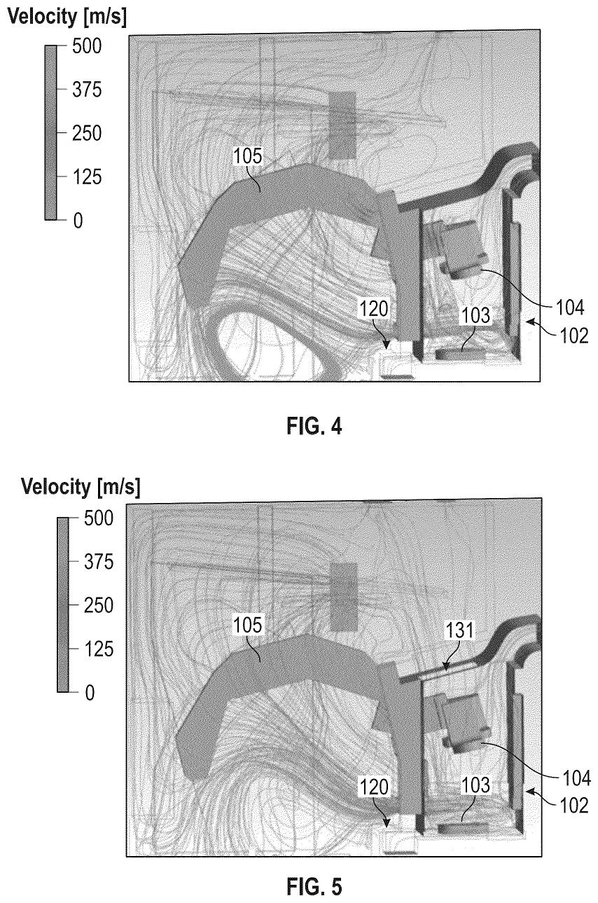

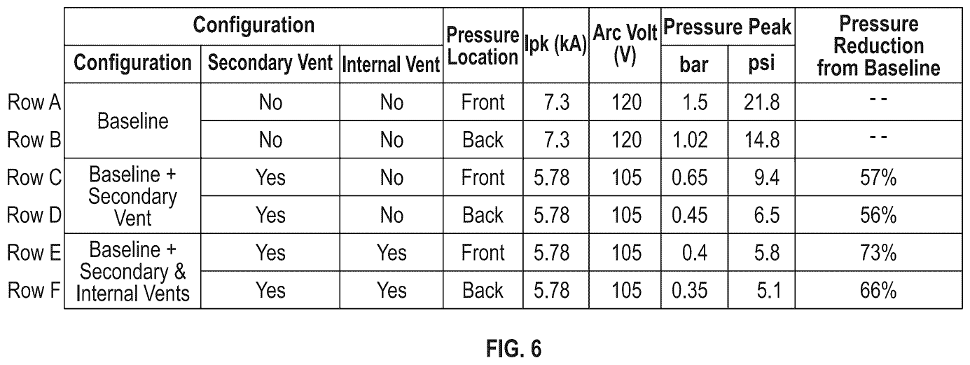

FIG. 4 depicts the flow of gas produced during arcing that results from the primary contacts 102 opening during a fault condition when the circuit interrupter 100 does not include the internal primary vent 131, such that the gas can only flow through the primary exhaust vent 120. It is noted that data for the setup depicted in FIG. 4 is shown in Rows A and B of Table 200 shown in FIG. 6, described in more detail later herein. FIG. 5 depicts the flow of gas the results from arcing when the primary contacts 102 open and the gas can flow through both the primary exhaust vent 120 and the internal primary vent 131. Data for the setup depicted in FIG. 5 is shown in Rows E and F of Table 200 shown in FIG. 6. In comparing FIG. 5 to FIG. 4, it can be seen that gases/heat are kept lower/closer to the primary contacts 102 in FIG. 4, and that there is significantly increased gas flow away from the immediate vicinity of the primary contacts 102 in FIG. 5 due to the internal primary vent 131, since the internal primary vent 131 in FIG. 5 enables significant gas flow in the upward direction (relative to the view shown in FIG. 5) in addition to the gas flow through the primary exhaust vent 120. It will thus be appreciated that, during an arcing event, pressure within the circuit breaker 100 is significantly decreased by the internal vent 131 increasing the flow of gas away from the primary contacts 102.

The circuit breaker 100 further includes a secondary exhaust vent 135 that vents gases produced by the secondary contacts 106 to the exterior of the circuit breaker housing 101. It will be appreciated that the secondary exhaust vent 135 is another feature that is not found in known circuit breakers, given that the secondary contacts 106 in series with the primary contacts 102 is a feature that is not found in known circuit breakers.

FIG. 6 is a comparison table 200 providing data demonstrating that adding the secondary contacts 106 in series with the primary contacts 102 in each pole of the circuit breaker 100 significantly reduces peak current, Ipk, and further demonstrating that adding a secondary vent and an internal vent significantly reduces the increase in the peak pressure in the interior of the circuit breaker 100 due to heat/energy released by arcing during opening of the primary contacts 102 and secondary contacts 106, as compared to a circuit breaker that does not have a secondary vent or an internal vent. Table 200 includes data that was recorded while simulating the same high-severity fault conditions (a short circuit event) and implementing three different venting configurations of the circuit breaker 100, under a 10 kA short circuit current rating. In addition, the data recorded in table 200 reflects two different configurations of separable contacts per pole, as detailed further below. The notation of “Front” or “Back” in the Location column of table 200 corresponds to a respective front location 201 and back location 202 as numbered in FIG. 1A, and indicates that simulation pressures were monitored at either the front location 201 or the back location 202. These front 201 and back 202 locations were chosen based on their proximities to the arcing zone between the primary contacts, with the front 201 being closer to the arc and the back 202 being relatively farther from the arc. It is noted that the back 202 location only sees the arc directly due to the inclusion of the primary internal vent 131 in the circuit breaker 100.

Continuing to refer to FIG. 6, Row A and Row B in table 200 contain data for measurements taken during a short circuit event where the circuit breaker 100 only included the primary contacts 102 in each pole (i.e. did not include the secondary contacts 106) and only included the primary exhaust vent 120 (i.e. without including the internal primary vent 131 or the secondary exhaust vent 135), with said configuration being labeled as “Baseline” in the table 200. The Baseline configuration is labeled as such since known circuit breakers only include one set of separable contacts per pole and only include a primary exhaust vent.

Row C and Row D in table 200 contain data for measurements simulated for a short circuit event where the circuit breaker 100 included secondary contacts 106 in series with the primary contacts 102 and included the secondary exhaust vent 135 in addition to the primary exhaust vent 120 (i.e. without including the internal primary vent 131), with said configuration being labeled as “Baseline+Secondary Vent” in the table 200. In comparing the data from Rows C and D to the data from Rows A and B, it can be seen that including the secondary contacts 106 in series with the primary contacts 102 in the observed pole of the circuit breaker 100 reduces peak current, Ipk, and that including the secondary exhaust vent 135 in addition to the primary exhaust vent 120 reduces the pressure increase within the circuit breaker 100 that results from opening both sets of separable contacts 102, 106. For example, for both the front location 201 and the back location 202, the peak current Ipk under the Baseline condition is over 7 kA (7.3 kA), and the peak current Ipk under the Baseline+Secondary Vent condition is less than 6 kA (5.78 kA). In addition, at the front location 201, there is a reduction in peak pressure of over 50% (value of 57% in last column of Row C), and at the back location 202, there is also a reduction in peak pressure of over 50% (value of 56% in last column in Row D).

Row E and Row F in table 200 contain data for measurements simulated for a short circuit event where the circuit breaker 100 included secondary contacts 106 in series with the primary contacts 102 and included all of the vents shown in FIG. 1A, i.e. the internal primary vent 131, the secondary exhaust vent 135, and the primary exhaust vent 120, with said configuration being labeled as “Baseline+Secondary & Internal Vents” in the table 200. In comparing the data from Rows E and F to the data from Rows C and D, Rows E and F show that even with the peak let through current Ipk being the same under the Baseline+Secondary Vent condition and under the Baseline+Secondary & Internal Vents condition, adding the internal primary vent 131 further reduces pressure within the circuit breaker 100. For example, for both the front location 201 and the back location 202, the peak current Ipk is 5.78 kA under both the Baseline+Secondary Vent condition and under the Baseline+Secondary & Internal Vents condition. However, for the front location 201, the pressure reduction for the Baseline+Secondary & Internal Vents condition is 16% greater than the Baseline+Secondary Vent condition (i.e. Row E value of 73% minus Row C value of 57%), and for the back location 202, the pressure reduction for the Baseline+Secondary & Internal Vents condition is 10% greater than the Baseline+Secondary Vent condition (i.e. Row F value of 66% minus Row D value of 56%).

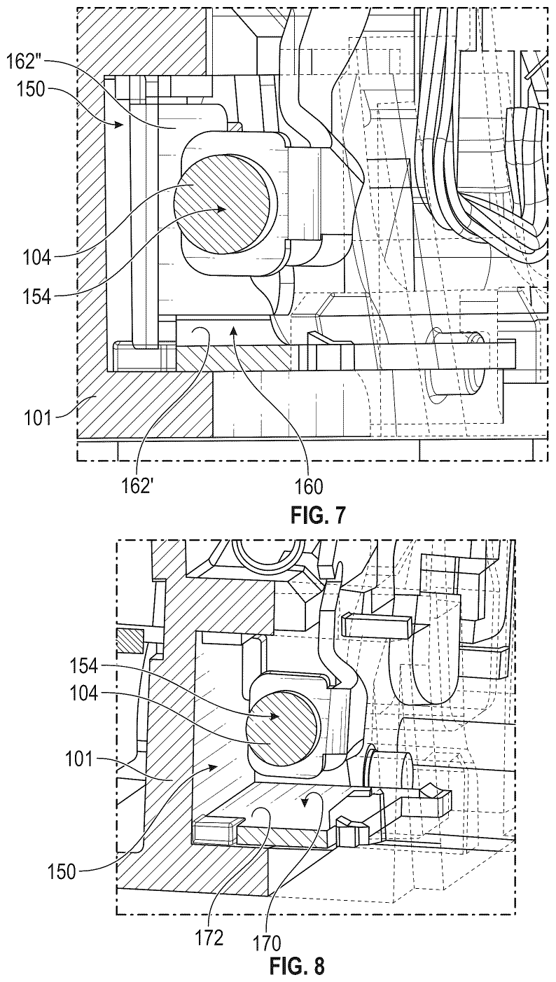

In addition to the inclusion and use of the secondary contacts 106, the primary external vent 120, the internal primary vent 131, and the secondary external vent 135 in the circuit breaker 100, the features of an arc chamber 150 included in the circuit breaker 100 can further mitigate the effects of arcing. FIG. 7 and FIG. 8 each show a different embodiment of an arc chute that can be included in an arc chamber 150 of the circuit breaker 100, the arc chutes being used to dissipate the arc generated when the primary contacts 102 separate. The arc chamber 150 is a portion of the housing 101 that forms a partial enclosure around the primary movable contact 104. Prior to detailing the arc chute embodiments, it is noted that there is a particular surface of the primary movable contact 104 that engages with the primary stationary contact 103 when the primary contacts 102 are closed, this particular surface being referred to hereinafter as an engagement surface 154 that is numbered in FIG. 7 and in FIG. 8.

Referring now to FIG. 7, an arc chamber 150 that includes a first embodiment 160 of an arc chute is shown, in accordance with an example embodiment of the disclosed concept. The arc chute 160 has a half-wrap design and is referred to hereinafter as the half-wrap arc chute 160. The half-wrap arc chute 160 comprises a plurality of chute surfaces 162 such that the chute surfaces 162 collectively are coincidental with a plurality of planes, the chute surfaces 162 being numbered 162′ and 162″ in FIG. 7 in order to be differentiable from one another. The chute surfaces 162 face the interior of the arc chamber 150 but do not face the engagement surface 154 of the primary movable contact 104. The chute surfaces 162 also do not face one another, as can be discerned when viewing chute surface 162′ and chute surface 162″.

Referring now to FIG. 8, an arc chamber 150 that includes a second embodiment 170 of an arc chute is shown, in accordance with another example embodiment of the disclosed concept. The arc chute 170 has a single plate design and is referred to hereinafter as the single plate arc chute 170. The single plate arc chute 170 comprises a single chute plate 172. The chute plate 172 is disposed such that a plane co-planar with the movable contact engagement surface 154 is perpendicular to the chute plate 172.

The data in table 200 was collected for an embodiment of the circuit breaker 100 that uses the half-wrap arc chute 160 in the chamber 150. It is noted that using the single plate arc chute 170 in the arc chamber 150 shows similar reductions in pressure and let-through energy as the half-wrap arc chute 160. The only notable difference between the half-wrap arc chute 160 and the single plate arc chute 170 is the increased ability of the half-wrap arc chute 160 to protect other components within the circuit breaker 100 during arcing generated by the primary contacts 102. For example, in some instances, the arc generated by the separation of the primary contacts 102 has been observed commutating to a mechanical spring 126 (numbered in FIG. 1A) of the circuit breaker 100, leading to annealing of the mechanical spring 126, and so it is desirable to implement the half-wrap arc chute 160 when the particular configuration of the circuit breaker 100 is expected to lead to an arc generated by the primary contacts 102 being commutated to other nearby components.

In sum, it can be appreciated from the foregoing detailed description that including the internal primary vent 131 and the secondary exhaust vent 135 in the disclosed improved circuit breaker 100, in combination with including the secondary contacts 106 and positioning the two sets of separable contacts 102 and 106 in series, causes greater reduction of pressure within the disclosed circuit breaker 100 compared to known circuit breakers, and can aid in achieving a higher short circuit rating for a circuit breaker such as a miniature circuit breaker (i.e. 22 kA for the disclosed circuit breaker 100 versus only 10 kA for known circuit breakers).

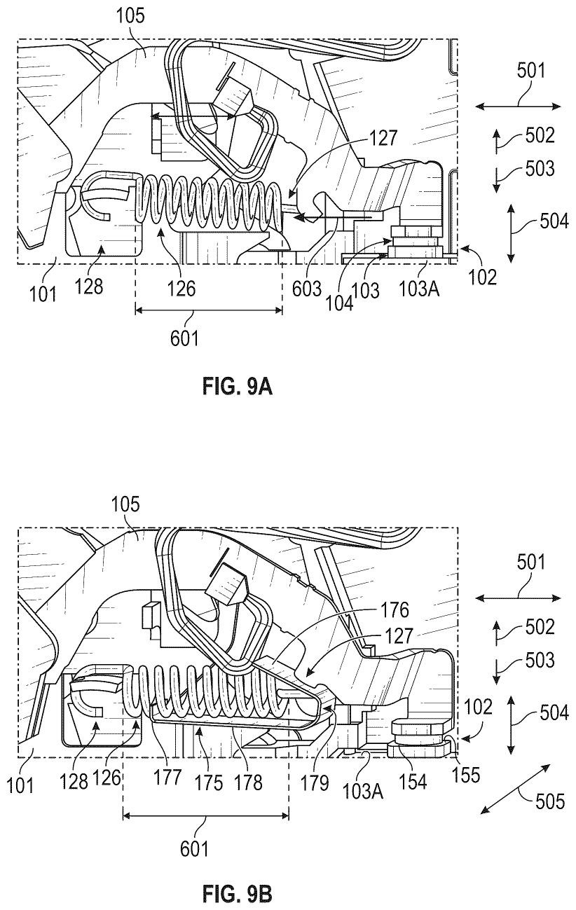

Some of the advantageous features described thus far in the present disclosure can additionally be modified in one or more ways to further improve the performance and/or extend the useful life of the circuit breaker 100, as will be described hereinafter in conjunction with FIGS. 9A-13C. Hereinafter, the term “primary side” is used to refer to the area of the circuit breaker 100 that is closer in proximity to the primary contacts 102 than to the secondary contacts 106. Conversely, the term “secondary side” is used hereinafter to refer to the area of the circuit breaker 100 that is closer in proximity to the secondary contacts 106 than to the primary contacts 102.

Reference is now made to FIGS. 9A-9B in order to describe modifications that can be made on the primary side in order to improve the performance and extend the useful life of the mechanical spring 126 (also shown in FIG. 1A). In particular, a spring guard 175 (shown in FIG. 9B) can be coupled to the mechanical spring 126, in accordance with an exemplary embodiment of the disclosed concept. As previously noted in connection with FIGS. 7-8, the surface of primary movable contact 104 that faces toward the primary stationary contact 103 is the engagement surface 154 (numbered in FIG. 9B) of the primary movable contact 104. The surface of the primary stationary contact 103 that faces toward the primary movable contact 104 is the engagement surface 155 (numbered in FIG. 9B) of the primary stationary contact 103. The engagement surfaces 154, 155 engage one another when the primary contacts 102 are closed. In FIGS. 9A and 9B, a primary side arm width dimension 501 is labeled. The primary side arm width dimension 501 specifically denotes a dimension in which the engagement surface 154 of the primary movable contact 104 extends, such that the primary side arm width dimension 501 is a dimension whose orientation is fixed relative to the primary movable arm 105.

As such, when the primary movable arm 105 moves, the orientation of the primary side arm width dimension 501 moves as well. For example, when the primary movable arm 105 is in the closed position as shown in FIGS. 9A-9B, the primary side arm width dimension 501 can be said to be parallel or co-planar with the engagement surface 155 of the primary stationary contact 103. However, when the primary movable arm 105 is in the open position as shown in FIGS. 4-5, the primary side arm width dimension 501 is disposed at an angle (albeit a relatively small angle) to the engagement surface 155 of the primary stationary contact 103, rather than being parallel with the engagement surface 155 of the primary stationary contact 103.

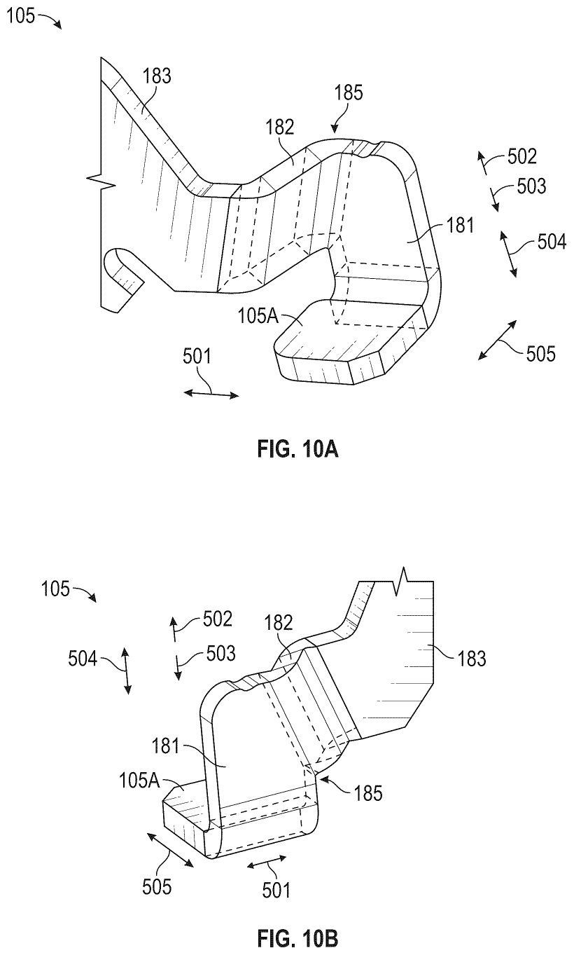

A primary side arm distal direction 502, a primary side arm proximal direction 503, and a primary side arm height dimension 504 are also labeled in FIGS. 9A-9B, and a primary side arm depth dimension 505 is also labeled in FIG. 9B. For brevity, in the discussion of FIGS. 9A-9B and 10A-10B, the dimensions and directions 501, 502, 503, 504, 505 are primarily referred to hereinafter as the “width dimension 501”, the “distal direction 502”, the “proximal direction 503”, the “height dimension 504”, and the “depth dimension 505”. The distal and proximal directions 502, 503 are opposed to one another and both lie in the height dimension 504. As with the width dimension 501, the orientations of the height dimension 504 (which includes the distal direction 502 and proximal direction 503) and the depth dimension 505 are fixed with respect to the primary movable arm 105. The depth dimension 505, width dimension 501, and height dimension 504 are all orthogonal to one another. The distal direction 502 indicates movement or orientation away from the primary stationary conductor 103A and the proximal direction 503 indicates movement or orientation toward the primary stationary conductor 103A. The terms “width”, “height”, and “depth” are used in the terms “primary side arm width dimension 501”, “primary side arm height dimension 504”, and “primary side arm depth dimension 505” solely to facilitate ease of understanding by differentiating each dimension from the other dimensions and should not be construed as limiting on the orientation in which the circuit breaker 100 can be used.

The mechanical spring 126 assists in coupling the primary movable arm 105 to the housing 101 of the circuit breaker 100. The mechanical spring 126 is coupled to the primary movable arm 105 so that the free length 601 of the mechanical spring 126 extends in the width dimension 501. A first end 127 of the mechanical spring 126 is coupled to the primary movable arm 105, and a second end 128 of the mechanical spring 126 is coupled to the housing 101. The first end 127 is the end of the mechanical spring 126 disposed closest to the primary movable contact 104, and the second end 128 is the end of the mechanical spring 126 disposed furthest away from the primary movable contact 104. In the setup of the circuit breaker 100 shown in FIG. 9A (which is the same as FIG. 1A), an arrow 603 is shown to indicate the direction in which hot gases from the arc chamber 150 flow. This flow 603 of hot gases can cause annealing of and/or other damage to the mechanical spring 126. Damage to the mechanical spring 126 after an arcing event (circuit breaker OFF position) could prevent the primary moving contact 104 from successfully engaging back with the primary stationary contact 103, when attempts are made to manually/automatically toggle the circuit breaker back ON. This would lead to a lack of continuity and current flow. Furthermore, damage to the mechanical spring 126 can compromise the coupling between the primary movable arm 105 and the housing 101 and decrease the contact pressure between the primary contacts 102 when the primary contacts 102 are in the closed position.

The damage caused by the flow 603 of hot gas can be prevented or significantly mitigated by installing the spring guard 175 (FIG. 9B) that is coupled at a first end 176 to the primary moving arm 105 and is coupled at a second end 177 to the mechanical spring 126. More specifically, the first end 176 of the spring guard 175 is coupled to the primary movable arm 105 such that the first end 176 provides a barrier between the mechanical spring's first end 127 and the primary movable contact 104 (when the primary contacts 102 are closed as shown in FIG. 9B, the first end 176 also provides a barrier between the spring's first end 127 and the primary stationary contact 103). The second end 177 of the spring guard 175 is physically interposed between two coils of the mechanical spring 126.

The primary movable arm 105 is curved such that there is space between the primary movable arm 105 and the mechanical spring 126 in the height dimension 504. The spring guard 175 comprises a main body 178 that is planar in the width and depth dimensions 501,505 and runs adjacent to a majority of the mechanical spring's free length 601. The spring guard 175 is structured so that, when it is installed in the primary side, the mechanical spring 126 is positioned between the spring guard's main body 178 and the primary movable arm 105 in the height dimension 504. Both the first end 176 and the second end 177 of the spring guard 175 are disposed at an angle to the main body 178. In particular, the second end 177 extends from the main body 178 in the distal direction 502. The spring guard 175 further comprises a curved portion 179 that extends in the distal direction 502 between the main body 178 and the first end 176, and the first end 176 extends from the curved portion 179 in both the width dimension 501 and the distal direction 502 such that the first end 176 overlaps with the main body 178 in the width dimension 501.

As can be seen in FIG. 9B, the outer diameter of the mechanical spring 126 lies in the depth dimension 505. Relative to the depth dimension 505, the spring guard 175 is at least as wide as the outer diameter of the mechanical spring 126. Non-limiting examples of materials from which the spring guard 175 can be produced include fishpaper, outgassing thermoplastic, and non-outgassing thermoset. However, any material that is electrically insulative, thermally insulative and/or VO-rated for flammability (UL 94 standard) is suitable.

Reference is now made to FIGS. 10A-10B in order to describe additional modifications that can be made to the primary movable arm 105 in order to prevent its degradation and extend its useful life. In particular, an insulating paint 185 can be applied to portions of the primary movable arm 105, in accordance with an exemplary embodiment of the disclosed concept. In FIGS. 10A-10B, a contact seating portion 105A of the primary movable arm 105 is numbered. The primary movable arm 105 is shown in FIGS. 10A-10B without the primary movable contact 104 attached, but the contact seating portion 105A is the portion of the primary movable arm 105 to which the primary movable contact 104 gets attached. The contact seating portion 105A is planar in the width and depth dimensions 501, 505. In viewing FIGS. 10A-10B in conjunction with other figures in which the primary movable contact 104 is shown (such as FIG. 9B), it should be understood that the engagement surface 154 of the primary movable contact 104 also extends in the width and depth dimensions 501, 505.

A seat adjacent portion 181 extends from the contact seating portion 105A in the distal direction 502. The seat adjacent portion 181 is planar in the width and height dimensions 501,504 such that most of the seat adjacent portion 181 is orthogonal to the contact seating portion 105A. An extension portion 182 extends from the seat adjacent portion 181 in the depth and width dimensions 505,501 such that most of the extension portion 182 is neither parallel nor orthogonal to the seat adjacent portion 181 or to the contact seating portion 105A. A main body 183 extends from the extension portion 182 in the width, depth, and height dimensions 501,505,504 and is neither parallel nor orthogonal to the extension portion 182. The main body 183 is planar in the width and height dimensions 501,504 such that most of the main body 183 is parallel to the seat adjacent portion 181 and orthogonal to the contact seating portion 105A.

Within a given pole of the circuit breaker 100, the specific orientation and shape of the primary stationary conductor 103A relative to the primary movable arm 105 can cause electric field magnification that leads to an arc attachment and a subsequent burnout of the primary movable contact 104. In order to prevent burnout of the primary movable contact 104, an insulating paint 185 can be applied to the seat adjacent portion 181 and the extension portion 182. The insulating paint 185 can be applied elsewhere if desired, but at a minimum, applying the insulating paint 185 to the seat adjacent portion 181 and the extension portion 182 has proven effective in preventing burnout of the primary movable contact 104.

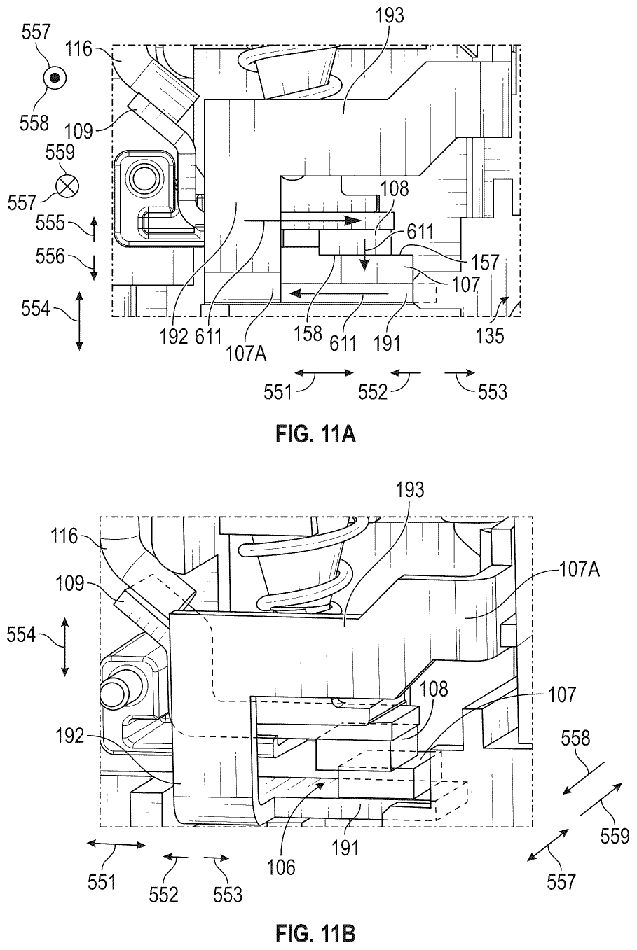

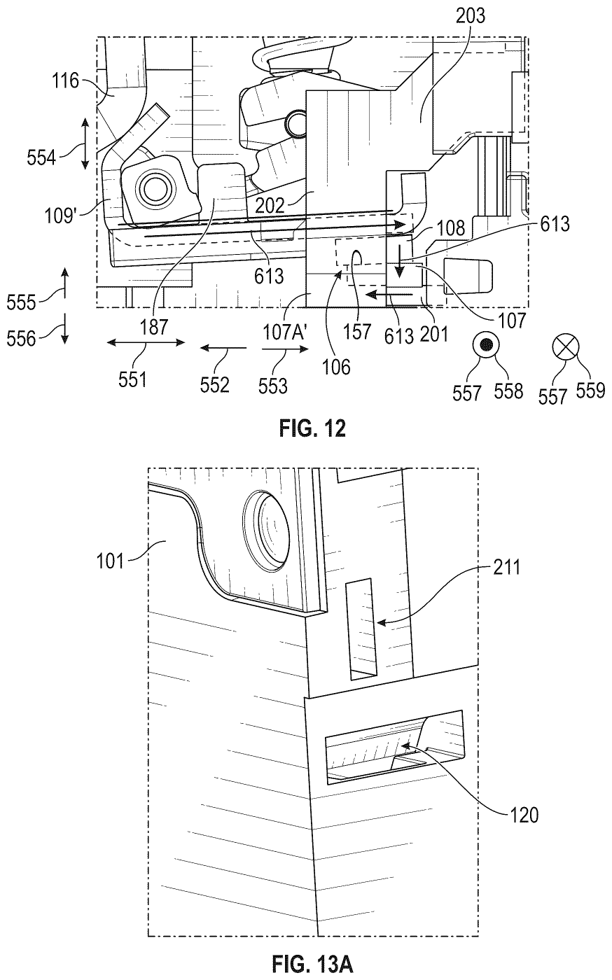

Reference is now made to FIGS. 11A-11B and FIG. 12 in order to describe modifications that can be made on the secondary side in order to improve the performance and extend the useful life of the secondary side components. In particular, modifying the proportions of certain sections of the secondary stationary conductor 107A (FIGS. 1A and 11A-11B) results in a secondary stationary conductor 107A′ (FIG. 12) having an advantageous structure, in accordance with an exemplary embodiment of the disclosed concept. FIG. 11A shows the secondary side as depicted in FIG. 1A, with more of the secondary stationary conductor 107A being visible in FIG. 11A due to the sectional view in FIG. 11A being cut along a different viewing plane than the viewing plane of FIG. 1A, the viewing plane of FIG. 11A being parallel to the viewing plane of FIG. 1A. The surface of the secondary stationary contact 107 that faces toward the secondary movable contact 108 is the engagement surface 157 of the secondary stationary contact 107 (numbered in FIG. 11A), and the surface of the secondary movable contact 108 that faces toward the secondary stationary contact 107 is the engagement surface 158 of the secondary movable contact 108 (numbered in FIG. 11A). The engagement surfaces 157, 158 engage one another when the secondary separable contacts 106 are closed.

A secondary side width dimension 551, a secondary side inward width direction 552, a secondary side outward width direction 553, a secondary side height dimension 554, a secondary side distal direction 555, a secondary side proximal direction 556, a secondary side depth dimension 557, a secondary side anterior direction 558, and a secondary side posterior direction 559 are labeled in FIGS. 11A-11B and FIG. 12. For brevity, in the discussion of FIGS. 11A-11B and FIG. 12, the dimensions and directions 551, 552, 553, 554, 555, 556, 557, 558, 559 are primarily referred to hereinafter as the “width dimension 551”, the “inward width direction 552”, the “outward width direction 553”, the “height dimension 554”, the “distal direction 555”, the “proximal direction 556”, the “depth dimension 557”, the “anterior direction 558”, and “the posterior direction 559”.

The depth dimension 557 is represented in FIG. 11A and FIG. 12 with a circled ‘x’ and a circled dot, as the depth dimension goes into and out of the viewing plane of FIG. 11A and FIG. 12. The anterior and posterior directions 558, 559 are opposed to one another and both lie in the depth dimension 557, with the anterior direction 558 indicating movement toward the viewer relative to the viewing plane of FIG. 11A and FIG. 12, and the posterior direction 559 indicating movement away from the viewer relative to the viewing plane of FIG. 11A and FIG. 12. FIG. 11B is a slightly rotated perspective of the view shown in FIG. 11A that shows the anterior and posterior directions 558, 559 in a viewing plane that is slightly angled relative to the width and height dimensions 551,554.

The inward width and outward width directions 552, 553 both lie in the width dimension 551. The width dimension 551, height dimension 554, and depth dimension 557 are all orthogonal to one another. The distal direction 555 and proximal direction 556 are opposed to one another and both lie with the height dimension 554. The distal direction 555 indicates movement or orientation away from the secondary stationary conductor 107A and the proximal direction 556 indicates movement or orientation toward the secondary stationary conductor 107A. The outward width direction 553 is so named because moving from secondary stationary contact 107 in the direction 553 leads to the environment external to the housing 101 faster than moving in the inward width direction 552 does (which can be seen when FIGS. 11A-11B and FIG. 12 are viewed in conjunction with FIG. 1A). Conversely, moving in the inward width direction 552 from the secondary stationary contact 107 leads further into the interior of the housing 101 toward the primary side.

The terms “width”, “height”, “anterior” and “posterior” are used in the terms “secondary side width dimension 551”, “secondary side width dimension 554”, “secondary side anterior direction 558”, and “secondary side posterior direction 559” solely to facilitate ease of understanding by differentiating each dimension from the other dimension and should not be construed as limiting on the orientation in which the circuit breaker 100 can be used. It should be noted that the secondary side width dimension 551 used to describe features of the secondary side shown in FIGS. 11A-11B and FIG. 12 is oriented differently from the primary arm width dimension 501 used to discuss features of the primary side shown in FIGS. 9A-9B and 10A-10B. It should also be noted that the secondary side height dimension 554 used to describe features of the secondary side shown in FIGS. 11A-11B and FIG. 12 is oriented differently from the primary arm height dimension 504 used to discuss features of the primary side shown in FIGS. 9A-9B. It should be further noted that the dimensions and directions 551, 552, 553, 554, 555, 556, 557, 558, 559 are fixed relative to the stationary components of the circuit breaker 100, such as the stationary contact 107.

Referring first to FIG. 11A, the secondary stationary conductor 107A and secondary movable arm 109 are designed to produce a reverse loop current path 611, which is depicted in FIG. 11A with three arrows numbered with the reference number 611. Reverse loop current paths are considered advantageous, as they result in very high interrupting capacities and provide current limiting characteristics. During high current interruption events on the secondary side, the reverse loop current path 611 has been found to push the arc towards the secondary exhaust vent 135 (the position of the secondary exhaust vent 135 relative to the secondary contacts 106 is indicated in FIG. 11A although the secondary exhaust vent 135 itself is not visible), rather than containing the arc between the secondary contacts 106. It will be appreciated that it is desirable to contain the reach of an arc as much as possible, in order to minimize the number of components that are exposed to the high heat and pressure of the arc.

Referring now to FIG. 12, certain modifications to the structures and configuration of the secondary stationary conductor 107A and the secondary movable arm 109 have proved to significantly curtail the reverse loop current path and contain significantly more of the arc between the secondary contacts 106. In FIG. 12, an embodiment 107A′ of the secondary stationary conductor and an embodiment 109′ of the secondary movable arm are used on the secondary side instead of the respective secondary stationary conductor 107A and secondary movable arm 109 shown in FIG. 11A, in order to achieve the aforementioned increased containment of the arc between the secondary contacts 106. The reverse loop current path 613 that results from the use of the secondary stationary conductor 107A′ and the secondary movable arm 109′ is depicted in FIG. 12 by the three arrows numbered with the reference number 613. In comparing the reverse loop current path 613 in FIG. 12 to the proportions of the secondary stationary conductor 107A′ and in comparing the reverse loop current path 611 in FIG. 11A to the proportions of the secondary stationary conductor 107A, the reverse loop current path 613 is shortened significantly compared to the reverse loop current path 611. In addition, an arm insulator 187 comprising insulative material is added to the secondary movable arm 109′ in FIG. 12 to withstand the intense heat generated during arcing, since the arc remains closer to the secondary contacts 106 when the secondary stationary conductor 107A′ and the secondary movable arm 109′ are used on the secondary side.

Regarding the modifications to the secondary side as shown in FIGS. 11A-11B that result in the reduced length reverse loop current path 613 shown in FIG. 12, the modifications made to the geometry of the secondary stationary conductor 107A (FIGS. 11A-11B) to produce the secondary stationary conductor 107A′ (FIG. 12) are most apparent. As shown in FIGS. 11A-11B, the secondary stationary conductor 107A comprises a contact seating portion 191, an extension portion 192, and a load connecting portion 193. The contact seating portion 191 is the portion of the secondary stationary conductor 107A to which the secondary stationary contact 107 is attached. The secondary stationary contact 107 is attached to the contact seating portion 191 such that the engagement surface 157 of the secondary stationary contact 107 extends in the width dimension 551. The extension portion 192 extends in the distal direction 555 from the contact seating portion 191 and is offset from the secondary stationary contact 107 in the width dimension 551.

Continuing to refer to FIGS. 11A-11B, a first end of the extension portion 192 is connected to the contact seating portion 191 and a second end of the extension portion 192 disposed opposite the first end is connected to the load connecting portion 193. The load connecting portion 193 extends from the extension portion 192 in the outward width direction 553 such that the load connecting portion 193 and the contact seating portion 191 overlap in the width dimension 551. The load connecting portion 193 is so named because it leads to a terminal that enables a load to be connected to the secondary stationary conductor 107A. Both the load connecting portion 193 and the contact seating portion 191 overlap with a majority of the secondary movable arm 109 in the width dimension 551. The extension portion 192 does not overlap with the secondary stationary contact 107 in the width dimension 551, while the load connecting portion 193 does overlap with the secondary stationary contact 107 in the width dimension 551.

Referring now to FIG. 12, it is noted that the secondary stationary conductor 107A′ comprises a contact seating portion 201, an extension portion 202, and a load connecting portion 203. The contact seating portion 201 is the portion of the secondary stationary conductor 107A′ to which the secondary stationary contact 107 is attached. The secondary stationary contact 107 is attached to the contact seating portion 201 such that the engagement surface 157 of the secondary stationary contact 107 extends in the width dimension 551. The extension portion 202 extends in the distal direction 555 and in the depth dimension 557 from the contact seating portion 201 and overlaps with the secondary stationary contact 107 in the width dimension 551. Relative to the viewing plane of FIG. 12, the extension portion 202 is disposed further in the anterior direction 558 relative to the secondary stationary contact 107.

Continuing to refer to FIG. 12, a first end of the extension portion 202 is connected to the contact seating portion 201 and a second end of the extension portion 202 disposed opposite the first end is connected to the load connecting portion 203. The load connecting portion 203 extends from the extension portion 202 in the outward width direction 553 such that the load connecting portion 203 and the contact seating portion 201 overlap in the width dimension 551. The load connecting portion 203 and the contact seating portion 201 shown in FIG. 12 are significantly shorter in the width dimension 551 compared to the respective load connecting portion 193 and contact seating portion 191 shown in FIG. 11A. As such, unlike the load connecting portion 193 and the contact seating portion 191, neither the load connecting portion 203 nor the contact seating portion 201 overlaps with a majority of the secondary movable arm 109 in the width dimension 551. In addition, the shorter length of the contact seating portion 201 causes the extension portion 202 (FIG. 12) to overlap with the secondary stationary contact 107, whereas the extension portion 192 (FIG. 11A) does not overlap with the secondary stationary contact 107 in the width dimension 501 due to the longer length of the contact seating portion 191. For clarity, it is noted that, relative to the viewing plane of FIG. 12, the extension portion 202 is disposed is disposed further in the anterior direction 558 relative to the contact seating portion 201, which is how the extension portion 202 is able to overlap with the contact seating portion 201 in the width dimension 551.

The modified structure of the secondary stationary conductor 107A′ of FIG. 12 confines the arc between the secondary contacts 106 significantly more than the secondary stationary conductor 107A of FIG. 11A does. While the structure of the secondary movable arm 109 (FIG. 11A) is modified somewhat to produce a secondary movable arm 109′ (FIG. 12) that accommodates the modified structure of the secondary stationary conductor 107A′ (FIG. 12) by being structured to enable the arm insulator 187 to be wrapped around the secondary movable arm 109′, the modified geometry of the secondary movable arm 109′ is not discussed in detail herein. The arm insulator 187 is added to the secondary side in the setup of FIG. 12 in order to enable the secondary movable arm 109′ to withstand the intense heat generated during arcing, as such heat is significantly increased in the setup of FIG. 12 relative to the setup of FIG. 11A due to the arc staying much closer to the secondary contacts 206 in FIG. 12 relative to FIG. 11A. Relative to the viewing plane of FIG. 12, the arm insulator 187 is coupled to the secondary movable arm 109′ so that the arm insulator 187 is positioned further in the anterior direction 558 relative to the secondary movable arm 109′ and so that the arm insulator 187 is positioned further in the posterior direction 559 relative to the extension portion 202. That is, the arm insulator 187 is coupled to the secondary movable arm 109′ so that the arm insulator 187 is positioned between the secondary movable arm 109′ and the secondary stationary conductor 107A′ in the depth dimension 557.

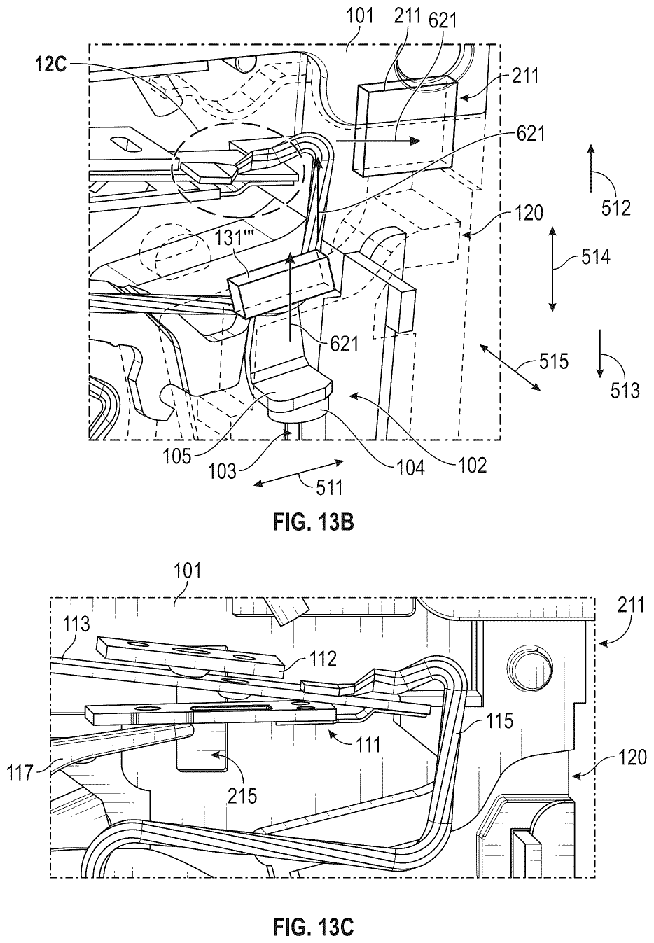

Reference is now made to FIGS. 13A-13C. FIGS. 13A and 13B show an auxiliary primary vent 211 that can be formed in the primary side in addition to the primary exhaust vent 120 shown in FIG. 1B, in accordance with an example embodiment of the disclosed concept. In FIG. 13B, because it can be difficult to discern between different overlapping pathways in the drawing, the air volume of a representative section of another embodiment 131′″ of the internal primary vent 131 (previously discussed in conjunction with FIGS. 1A, 3A, and 3B) is emphasized with a box numbered 131′″, and the air volume of a representative section of the auxiliary primary vent 211 is emphasized with a second box numbered 211. The boxes 131′″ and 211 are provided in FIG. 13B to symbolically depict a cross-section of a portion of the pathway from the interior of the primary side to the internal primary vent 131 and finally, to the auxiliary primary vent 211. It should be understood that the first box 131′″ and second box 211 are not structures that are physically present in the primary side, they are simply voids.

The internal primary vent 131 is emphasized in FIG. 13B along with the auxiliary primary vent 211, because without the internal primary vent 131, the path of exhaust gases towards the auxiliary primary vent 211 would be significantly longer. As previously noted in conjunction with FIGS. 3A and 3B, the internal primary vent 131 can vary in depth and cross-section without departing from the scope of the disclosed concept, and the geometry of the internal primary vent 131 can be adjusted depending on how exhaust gas needs to be routed. The specific embodiment 131′″ shown in FIG. 13B has a geometry that facilitates the flow of exhaust gases toward the auxiliary primary vent 211. An exhaust path 621 is depicted in FIG. 13B with three arrows numbered with the reference number 621. The exhaust path 621 begins where the primary contacts 102 are located (only the primary movable contact 104 is visible in FIG. 13B) and ends at the auxiliary primary vent 211.

In FIG. 13B, a primary side fixed width dimension 511, primary side fixed distal direction 512, a primary side fixed proximal direction 513, a primary side fixed height dimension 514, and a primary side fixed depth dimension 515 are numbered. For brevity, in the discussion of FIGS. 13A-13C, the dimensions and directions 511, 512, 513, 514, 515 are primarily referred to hereinafter as the “fixed width dimension 511”, the “fixed distal direction 512”, the “fixed proximal direction 513”, the “fixed height dimension 514”, and the “fixed depth dimension 515”. The fixed width dimension 511, fixed height dimension 514, and fixed depth dimension 515 are all orthogonal to one another. The fixed distal direction 512 and fixed proximal direction 513 are opposed to one another and both lie in the fixed height dimension 514.

The fixed width dimension 511 corresponds generally to the primary side arm width dimension 501, the fixed distal direction 512 corresponds generally to the primary side arm distal direction 502, the fixed proximal direction 513 corresponds generally to the primary side arm proximal direction 513, the fixed height dimension 514 corresponds generally to the primary side arm height dimension 504, and the fixed depth dimension 515 corresponds generally to the primary side arm depth dimension 505. However, the dimensions and directions 511, 512, 513, 514, 515 are fixed relative to the housing 101, whereas the dimensions and directions 501, 502, 503, 504, 505 are fixed relative to the primary movable arm 105.

The fixed width dimension 511 and the fixed depth dimension 515 are the dimensions in which the engagement surface 155 (not visible in FIG. 13A, visible in FIG. 9B for reference) of the primary stationary contact 103 extends. In FIG. 13B, movement in the distal direction 512 indicates movement away from the separable contacts 102 and movement in the proximal direction 513 indicates movement toward the separable contacts 102. The primary exhaust vent 120 is spaced a first distance away from the primary stationary contact 103 in the distal direction 512, and the auxiliary primary vent 211 vent is spaced a second distance away from the primary stationary contact 103 in the distal direction 512, such that the auxiliary primary vent 211 is positioned further away from the primary stationary contact 103 in the distal direction 512 than the primary exhaust vent 120 is.

In FIG. 13C, a PCBA (PCB assembly) compartment window 215 formed in the housing 101 is shown. It is noted that the auxiliary primary vent 211 is not discernible in the specific sectional view shown in FIG. 13C, but its relative location is indicated. Within each pole in the circuit breaker 100, the housing 101 is structured to provide a barrier between a PCBA side of the pole and the primary side of the pole, with the primary side of the pole holding the electromechanical components and the PCBA side holding the monitoring and control components, such as the PCB 8 (FIG. 2). In FIGS. 13B and 13C, the primary side is shown, and the PCBA compartment window 215 shown in FIG. 13C extends between the primary side and PCBA side. The PCBA compartment window 215 is formed because certain components on the PCBA side and on the primary side cooperate with one another to actuate the primary contacts 102 and thus extend between the PCBA side and the primary side through the PCBA compartment window 215, although these components are omitted in FIG. 13C so that the PCBA compartment window 215 can be seen more clearly.

When the auxiliary primary vent 211 together with the internal primary vent 131 are used in conjunction with the primary exhaust vent 120 on the primary side of a given pole of the circuit breaker 100, hot exhaust gases can be cleared from the primary side noticeably more efficiently than when the primary exhaust vent 120 is used alone on the primary side. The exhaust path 621 (FIG. 13B) created by the auxiliary primary vent 211 and the internal primary vent 131 is particularly advantageous because it prevents a significant portion of hot gases from flowing through the PCBA compartment window 215 toward the PCBA side of the pole. Preventing and minimizing the amount of hot gas that flows toward the PCBA side is important for preventing damage to the monitoring and control components of the circuit breaker 100 and preserving the dielectric properties of the circuit breaker 100. In addition, although not shown in the figures, it is noted that a stainless steel plate can be used to reinforce the bimetal junction between the bimetal strip 113 (FIGS. 13C, 1A, 3A-3B) and the armature 111 (FIGS. 13C, 1A, 3A-3B) to help the bimetal junction better withstand the force of the exhaust gases produced in the arc chamber 150 (FIGS. 7-8).

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A circuit breaker, the circuit breaker comprising:
a housing;
a line side structured to electrically connect to a power source;
a load side structured to electrically connect to a load;
a first set of separable contacts, the first set of separable contacts being primary contacts electrically connected between the line side and the load side;
a secondary stationary conductor;
a secondary movable arm;
a second set of separable contacts, the second set of separable contacts being secondary contacts electrically connected between the line side and the load side, the secondary contacts including a secondary stationary contact attached to the secondary stationary conductor and a secondary movable contact attached to the secondary movable arm;
a thermal magnetic arrangement configured to open the primary contacts from a closed state once current reaches a predetermined severity threshold;
a secondary actuator structured to actuate the secondary movable arm to open the secondary stationary contact from a closed state;
a printed circuit board, PCB, the PCB being structured to monitor electrical conditions in the circuit breaker and actuate the secondary actuator;
an internal primary vent structured to vent gas away from the vicinity of the primary contacts and into an area internal to the housing; and
a secondary exhaust vent structured to vent gas away from the secondary contacts to an exterior of the housing,
wherein the primary contacts and the secondary contacts are in series, wherein the PCB is configured such that, when the primary contacts are closed and the secondary contacts are closed, the PCB actuates the secondary actuator to open the secondary contacts simultaneously during thermal-magnetic opening of the primary contacts in response to detecting a fault condition exceeding a predetermined severity threshold,
wherein secondary stationary conductor comprises a secondary contact seating portion, a secondary extension portion, and a load connecting portion,
wherein the secondary stationary contact is attached to the secondary contact seating portion and comprises an engagement surface that extends in a secondary side width dimension,
wherein the secondary extension portion extends in a secondary side height dimension and in a secondary side depth dimension from the secondary contact seating portion,
wherein the secondary extension portion overlaps with the secondary stationary contact in the secondary side width dimension,
wherein the secondary side width dimension, the secondary side height dimension, and the secondary side depth dimension are all orthogonal to one another, and
wherein the load connecting portion extends from the secondary extension portion in the secondary side width dimension such that the load connecting portion and the secondary contact seating portion overlap in the secondary side width dimension.

2. The circuit breaker of claim 1, further comprising:
an arm insulator wrapped around the secondary movable arm.

3. The circuit breaker of claim 1, further comprising:
further comprising an auxiliary primary vent structured to vent gas away from the vicinity of the primary contacts to the exterior of the housing.

4. The circuit breaker of claim 3,
wherein the primary contacts include a primary stationary contact having an engagement surface,
wherein the engagement surface extends in a fixed width dimension and in a fixed depth dimension,
wherein the primary exhaust vent is spaced a first distance away from the primary stationary contact in a fixed height dimension,
wherein the fixed width dimension, the fixed depth dimension, the fixed height dimension are all orthogonal to one another, and
wherein the auxiliary vent is spaced a second distance away from the primary stationary contact in the fixed height dimension, such that the auxiliary vent is positioned further away from the primary stationary contact in the fixed height dimension than the primary exhaust vent is.

5. The circuit breaker of claim 1, further comprising:
a primary stationary conductor; and
a primary movable arm, the primary movable arm comprising:
a primary contact seating portion;
a seat adjacent portion;
a primary extension portion; and
a main body,
wherein the primary contacts include a primary stationary contact attached to the primary stationary conductor and a primary movable contact attached to the primary contact seating portion,
wherein an engagement surface of the primary stationary contact extends in a primary side arm width dimension,
wherein the seat adjacent portion extends from the contact seating portion in a primary side arm height dimension,
wherein the primary extension portion extends from the seat adjacent portion in a primary side arm depth dimension and in the primary side arm width dimension,
wherein the main body extends from the extension portion in the primary side arm width dimension and in the primary side arm height dimension, and
wherein the primary side arm width dimension, the primary side arm height dimension, and the primary side arm depth dimension are all orthogonal to one another.

6. The circuit breaker of claim 5,
wherein the seat adjacent portion and the extension portion are coated in insulating paint.

7. The circuit breaker of claim 6,
wherein the seat adjacent portion is planar in the primary side arm width and height dimensions such that most of the seat adjacent portion is orthogonal to the contact seating portion.

8. The circuit breaker of claim 7,
wherein most of the extension portion is neither parallel nor orthogonal to the seat adjacent portion or to the contact seating portion.

9. The circuit breaker of claim 8,
wherein the main body is neither parallel nor orthogonal to the extension portion.

10. The circuit breaker of claim 9,
wherein the main body is planar in the primary side arm width and height dimensions such that most of the main body is parallel to the seat adjacent portion and orthogonal to the contact seating portion.

11. The circuit breaker of claim 1, further comprising:
a primary stationary conductor; and
a primary movable arm, the primary movable arm comprising a primary contact seating portion; and
a mechanical spring that assists in coupling the primary movable arm to the housing, the mechanical spring having a free length,
wherein the primary contacts include a primary stationary contact attached to the primary stationary conductor and a primary movable contact attached to the primary contact seating portion,
wherein an engagement surface of the primary stationary contact extends in a primary side arm width dimension,
wherein the mechanical spring is coupled to the primary movable arm so that the free length extends in the primary side arm width dimension, and
wherein a first end of the mechanical spring is coupled to the primary movable arm and a second end of the mechanical spring is coupled to the housing, the first end being an end of the mechanical spring disposed closest to the primary movable contact and the second end being an end of the mechanical spring disposed furthest away from the primary movable contact.

12. The circuit breaker of claim 11, further comprising:
a spring guard, the spring guard being coupled at a first end to the primary moving arm and being coupled at a second end to the mechanical spring,
wherein, the first end of the spring guard is coupled to the primary movable arm such that the first end of the spring guard provides a barrier between the first end of the mechanical spring and the primary movable contact.

13. The circuit breaker of claim 12,
wherein the second end of the spring guard is physically interposed between two coils of the mechanical spring.

14. The circuit breaker of claim 12,
wherein the primary movable arm is curved such that there is space between the primary movable arm and the mechanical spring in a primary side arm height dimension, the primary side arm height dimension being orthogonal to the primary side arm width dimension,
wherein the spring guard comprises a main body that is planar in the primary side arm width dimension and runs adjacent to a majority of the free length, and
wherein the spring guard is structured such that the mechanical spring is positioned between the main body of the spring guard and the primary movable arm in the primary side arm height dimension.

15. The circuit breaker of claim 14,
wherein the first end and the second end of the spring guard are disposed at an angle to the main body of the spring guard, and
wherein the first end of the spring guard overlaps with the main body of the spring guard in the primary side arm width dimension.

16. The circuit breaker of claim 12,
wherein an outer diameter of the mechanical spring lies in a primary side arm depth dimension, the primary side arm depth dimension being orthogonal to the primary side arm width dimension, and
wherein relative to the primary side arm depth dimension, the spring guard is at least as wide as the outer diameter of the mechanical spring.

17. The circuit breaker of claim 12,
wherein the spring guard is produced from fishpaper, outgassing thermoplastic, or non-outgassing thermoset.
